(19) United States
(12) Patent Application Publication
(10) Pub. No.: US 2014/0123512 A1
(43) Pub. Date: May 8, 2014

(54) Writing pad and holder

(71) Applicants: Jon Jason Linker, Morro Bay, CA (US); Steve Molnar, Los Osos, CA (US); Blake Juhl, Sandy, UT (US)

(72) Inventors: Jon Jason Linker, Morro Bay, CA (US); Steve Molnar, Los Osos, CA (US); Blake Juhl, Sandy, UT (US)

(21) Appl. No.: 13/694,169

(22) Filed: Nov. 5, 2012

(51) Int. Cl. B42D 5/00; G01B 3/10

(52) U.S. Cl. CPC B42D 5/006; G01B 3/1084
USPC 33/760; 281/44

(57) ABSTRACT

A writing pad and holder with a writing pad consisting of a uniform stack of paper sheets, a semi-permanent adhesive backing strip, a pad holding member, a permanent double sided adhesive strip. Each paper sheet has a semi-permanent adhesive backing strip centrally attached to its rear surface. The writing pad fits in a depression in the pad holding member. The pad holding member has a cut out portion allowing the user to access the edge of each paper sheet. The paper sheet has an optional visual indicating feature that helps the user know the proper orientation of the pad in relationship to the cut out portion of the pad holder. The semi-permanent adhesive backing strip is fixed in a perpendicular orientation with respect to the cut out portion of the rigid pad holding member. The pad holder is attached to a tape measure housing with the permanent double adhesive strip.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of writing accessories and more specifically to a writing pad and holder.

The use of tape measures while doing construction projects is well known. A tape measure is typically comprised of a ribbon of thin steel that has markings printed on it and is rolled up into a housing. The user pulls the tape out to measure a length, for example a length of wood, so that it may be cut to the proper length for its intended use. During the process of measuring it is often necessary to record the length on a sheet of paper or the like so that it might be referred to when the actual cutting takes place. To this end, the person doing the measuring and cutting requires some form of writing surface to be in convenient and close proximity to the job being done. Many carpenters have a pad of paper in their pockets. Some simply write, with a pencil, on any convenient surface and then erase the markings if necessary at a later time. There is a deficiency in this type of record keeping activity in that one can not always count on the fact that an appropriate writing surface will always be at close hand. It is particularly important to have the writing surface within arms length while measuring so that one does not have to interrupt that measuring activity to record a numerical dimension. The ideal solution would be one where the writing surface was attached to the tape measure, making it unnecessary to carry and use a separate item. It would be even more ideal to have a pad of paper attached to the tape measure so that a fresh sheet of paper could be available for each measuring activity. It would be most ideal for the pad of paper to be constructed in such a way that each sheet was securely attached in close proximity to the side of the tape measure housing until it is needed to be removed. Other applications include but are not limited to attachment to a vehicle dashboard, any wall surface, the side of a refrigerator or other piece of furniture, and to the outer surface school notebook

### BRIEF SUMMARY OF THE INVENTION

The primary object of the invention is to provide a writing pad that includes a plurality of flat paper sheets that each have a strip of semi permanent adhesive centrally fixed to their rear surface.

Another object of the invention is to provide a writing pad where the paper sheets are circular in shape.

Another object of the invention is to provide a writing pad where the paper sheets are other non standard shapes such as hexagonal or octagonal.

Another object of the invention is to provide a circular shaped writing pad that fits into a depression in a rigid circular pad holder where a side ridge protects the edges of the pad of paper from being disturbed.

A further object of the invention is to provide a circular shaped writing pad that can be mounted in a rigid circular pad holder which is sized to attach to the side of a standard tape measure housing with a double sided adhesive strip.

A further object of the invention is to provide protection of the circular shaped writing pad during typical use including storing and retracting from a contractors tool bag and or pocket.

Yet another object of the invention is to provide a visual indicator that helps the user find the correct orientation for mounting the circular pad into the holder.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a writing pad and holder comprising: a writing pad having of a plurality of sheets of identically sized paper stacked on top of each other, a semi-permanent adhesive backing strip, a rigid pad holding member, a permanent double adhesive strip attachment means, each said paper sheet having a front side and a rear side, said semi-permanent adhesive backing strip centrally attached to said rear side of each said paper sheet, said writing pad capable of fitting in a depression in said rigid pad holding member, the last said semi permanent adhesive strip attaching said pad to the flat depressed floor of said pad holding member, said rigid pad holding member including a cut out portion allowing the user access to an edge of said paper sheet, said paper sheet including an optional visual indicating means for helping know the proper orientation of said writing pad in relationship to said cut out portion of said rigid pad holding member, said semi-permanent adhesive backing strip fixed in a horizontal orientation with respect to said cut out portion of said rigid pad holding member and, said pad holding member attached to the side of a standard tape measure housing by said permanent double adhesive attachment strip.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention mounted to a standard tape measure.

FIG. 2 is an exploded view of the invention.

FIG. 3 is a rear view of one sheet of the pad.

FIG. 4 is a front view of one sheet of the pad.

FIG. 5 is a front view of an alternate embodiment of the pad.

FIG. 6 is a perspective view of the invention by itself.

FIG. 7 is a front view of the invention mounted onto a tape measure.

FIG. 8 is a side section view of the invention mounted onto a tape measure.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

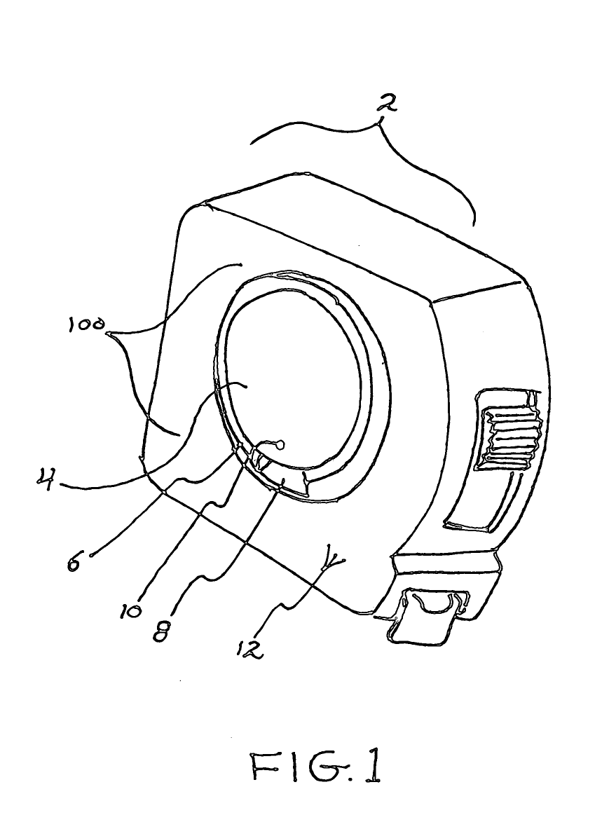

Referring now to FIG. 1 we see the pad 4 and pad holder 6 of the present invention 100 mounted on the side 12 of a standard tape measure housing 2. A cut out portion 8 in the rigid pad holder 6 allows a person to easily remove a single sheet of paper at a time from the pad 4. An optional indicating dot 10 tells the user how to orient the pad 4 into the holder 6 in a way that orients the portion of the paper that does not include adhesive in a perpendicular position with respect to the cut out portion 8 so that the user has access to a portion of the paper sheet that does not have adhesive on it.

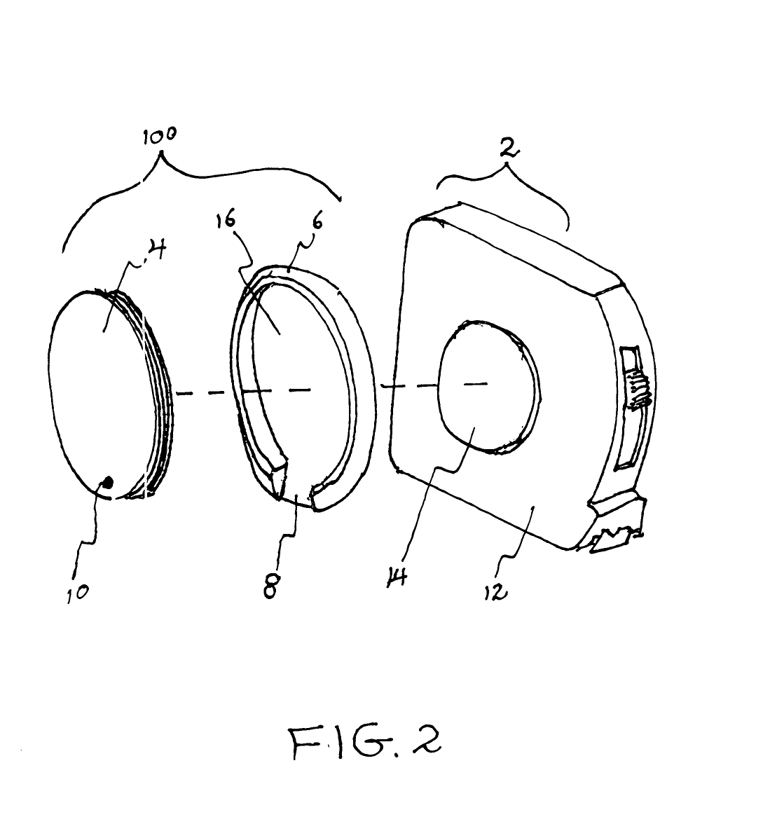

FIG. 2 shows an exploded view of the invention 100. Pad 4 is preferably round in shape and can be inserted into a depression 16 in rigid pad holder 6. The last sheet of paper in the pad 4 is held to the floor of the depressed area 16 by the semi permanent adhesive 18 found on the rear of each sheet of the pad 4. The pad holder 6 is attached to the side 12 of the tape measure housing 2 by a double sided adhesive 14 strip. In the preferred embodiment, the double sided adhesive strip 14 is a die cut round shape.

Of course, the pad 4 and pad holder 6 may be other shapes, such as square, hexagonal or octagonal. The location of the pad 4 and pad holder 6 makes it easy for a user to write down crucial measurements or other relevant information without needing an additional pad of paper or other writing surface. This is time saving because one does not have to put down the tape measure to pick up a separate writing pad and then reverse that process to begin taking measurements again.

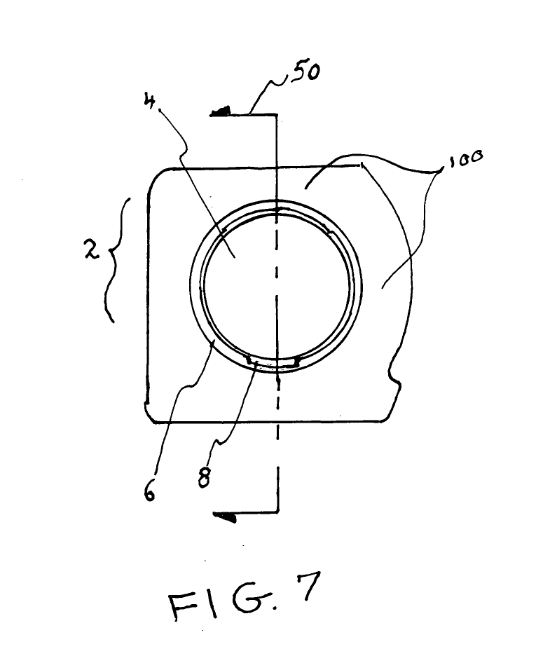

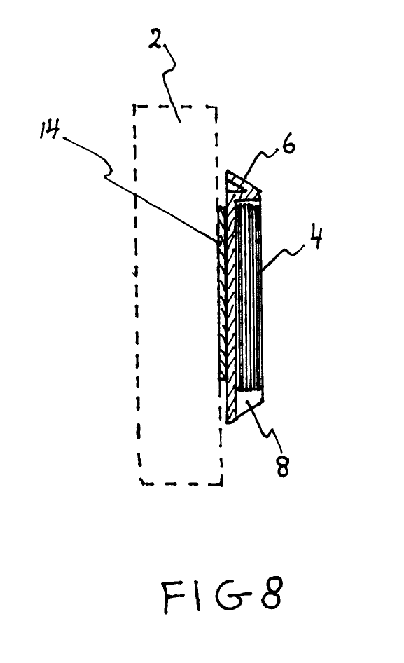

Because the pad 4 is placed in the recessed 16 portion of the rigid holder 6, the edges of the sheets of the pad 4 are protected when the tape measure 2 is stored in a tool box or pocket. The cut out portion 8 can be clearly seen in the side section view shown in FIG. 8 as defined by section line 50 shown in a front view of FIG. 7.

Obviously the present invention 100 can be used for other purposes and mounted in other locations such as on the dashboard of a vehicle, the side of a piece of furniture, on a wall, or on the outer surface of a notebook.

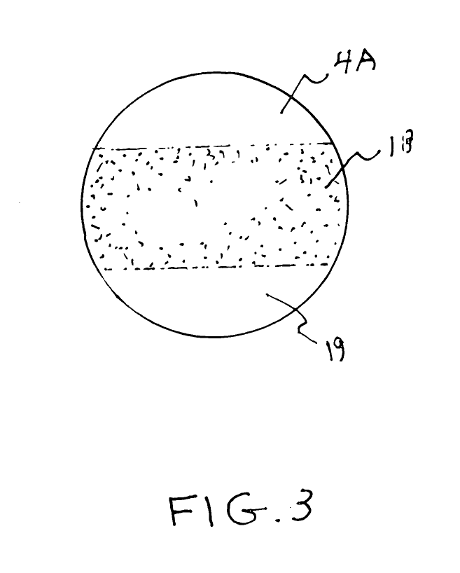

FIG. 3 shows a rear plan view of a sheet of paper 4A of pad 4. A centrally located strip of semi-permanent adhesive 18 such as that found on “Post-it” branded pads by the 3M Company. The location of the semi-permanent adhesive strip 18 keeps each paper sheet 4A attached to each sheet above it in a way where the sheets can not accidentally flap open, which would be the case if the sheets were attached in the normal way, at one edge. It should be noted that in one embodiment of invention the entire rear surface of each sheet 4A can be covered with the semi-permanent adhesive 18 except for the lower portion 19 which needs to be free of adhesive so that the user can have easy access to each sheet 4A for easy removal.

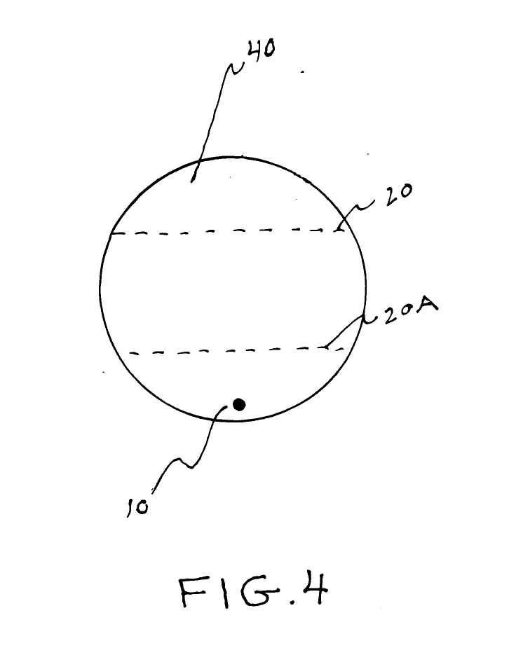

FIG. 4 shows a front view of a sheet 40 where the centrally located, horizontally disposed semi permanent adhesive strip is represented by dotted lines 20, 20A. Indicator dot 10 is shown at the bottom portion of the sheet 40. Each sheet has such a marking 10. When the indicator dot 10 is placed near the bottom edge of the rigid pad holder 6, it allows the user to have access, via cut out portion 8, to a portion of the sheet 40 that does not have adhesive on it and therefore is easy to remove from the rigid pad holder 6.

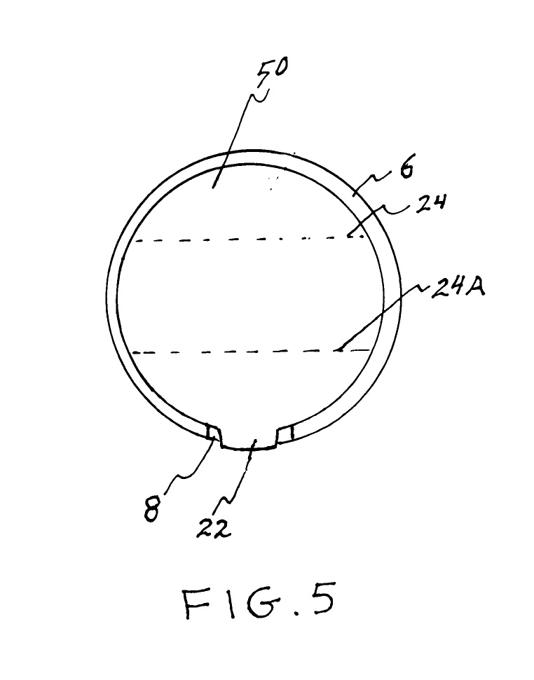

An alternate method of indicating the proper pad orientation is to have a tab 22 as shown in FIG. 5 that extends out from sheet 50, and to have that tab coincide with the cut out portion 8, which causes the semi-adhesive strip, shown by dotted lines 24, 24A to be in a perpendicular orientation with relation to the cut out portion 8, insuring that the user can easily grab hold of and remove one sheet 50 at a time.

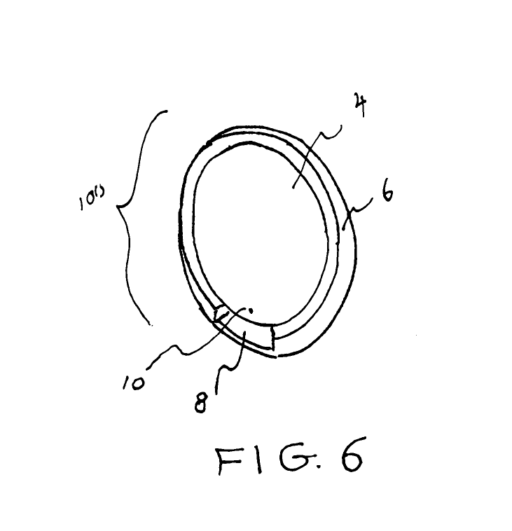

FIG. 6 is a perspective view of the invention 100 with the pad 4 inserted into the depression in rigid housing 6. Cut out portion 8 can be clearly seen as well as the close proximity of indicator dot 10 in relation to the cut out portion 8.

Of course, the present invention can be used in other environments, such as on the surface of a refrigerator in a kitchen, or on the dashboard of a vehicle.

Additionally, an obvious alternate embodiment can be envisioned where the pad holding member 6 can be fully integrated into the side wall of a standard tape measure device so that no permanent adhesive strip is needed to hold a separate pad holder 6 to the side of a tape measure device 2.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. writing pad and holder comprising:
a writing pad consisting of a plurality of sheets of identically sized paper stacked on top of each other;
a semi-permanent adhesive backing portion;
a rigid pad holding member;
a permanent double sided adhesive attachment member;
each said paper sheet having a front side and a rear side;
said semi-permanent adhesive backing portion centrally attached to said rear side of each said paper sheet;
said writing pad capable of fitting in a depression in said rigid pad holding member;
the last sheet of said pad attached to the floor of said rigid pad holding member by said semi-permanent adhesive backing portion;
said rigid pad holding member including a cut out portion allowing a user to access an edge of said paper sheet;
said semi-permanent adhesive backing portion positioned so that no said semi-adhesive backing portion is found near the location of said cut out portion of said rigid pad holding member and
said rigid pad holding member held to the side of a standard tape measure device or other flat surface by said permanent double sided adhesive attachment member.

2. A writing pad and holder as claimed in claim 1 wherein said paper sheet includes the application of a visual indicating means for helping a user know the proper orientation of said writing pad so that the portion of said pad that does not include semi-adhesive is in alignment to said cut out portion of said rigid pad holding member.

3. A writing pad and holder as claimed in claim 2 wherein said visual indicating means includes a graphic printed mark located at the lower portion of said paper sheet so that said lower mark is in close proximity to said cut out portion of said rigid pad holding member and insuring that said semi-permanent adhesive backing strip is in a perpendicular orientation with respect to said cut out portion.

4. A writing pad and holder as claimed in claim 1 wherein said writing pad is circular in top plan view.

5. A writing pad and holder as claimed in claim 1 wherein said rigid pad holding member is round in top plan view and sized to fit on the side of a standard tape measure housing.

6. A writing pad and holder as claimed in claim 1 wherein an alternate embodiment of said visual indicating means includes an integral tab added to each said sheet;
said tab in alignment with said cut out portion of said rigid pad holding member;
said tab insuring the correct orientation of said paper sheets;
said tab insuring that said semi-permanent adhesive strip is in a perpendicular orientation in relation to said cut out portion of said rigid pad holding member.

7. An alternate embodiment of the writing pad and holder as claimed in claim 1 wherein said holder is formed as an integral part of the side wall of a tape measure device.

8. An alternate embodiment of the writing pad and holder as claimed in claim 1 wherein said holder and writing pad are hexagonal or octagonal in shape.
